(19) United States
(12) Patent Application Publication
(10) Pub. No.: US 2006/0248133 A1
(43) Pub. Date: Nov. 2, 2006

(54) Modified transposed farrow structure

(75) Inventor: Wenzhen Li, Singapore (SG)

Correspondence Address: QUARLES & BRADY LLP, 411 E. WISCONSIN AVENUE, SUITE 2040, MILWAUKEE, WI, 53202-4497, US

(73) Assignee: Oki Techno Centre (Singapore) Pte Ltd

(21) Appl. No.: 11/401,671

(22) Filed: Apr. 11, 2006

(30) Foreign Application Priority Data
Apr. 29, 2005 (SG) 200502778-4

(51) Int. Cl. G06F 15/00

(52) U.S. Cl. 708/200

(57) ABSTRACT

There is provided a transposed Farrow structure for a receiver for a Software Defined Radio (SDR) system, a feedforward synchronizer for an SDR receiver comprising such a transposed Farrow structure and a method for processing a received signal in an SDR receiver. The transposed Farrow structure is arranged to implement: a) sample rate conversion (SRC) for converting a received signal r having a sampling rate of 1/T₁ to a transmitted signal y having a sampling rate of 1/T₂ b) timing adjustment using an estimated timing error τ; and c) matched filtering of the received signal. The feedforward synchronizer includes the transposed Farrow structure and a feedforward estimator for generating an estimated timing error τ. The method includes the steps of performing, in the transposed Farrow structure, sample rate conversion (SRC) for converting received signal r having a sampling rate of 1/T₁ to a transmitted signal y having a sampling rate of 1/T₂; performing, in the transposed Farrow structure, timing adjustment using an estimated timing error τ; and performing, in the transposed Farrow structure, matched filtering of the received signal.

### FIELD OF THE INVENTION

The invention relates to a transposed Farrow structure for a receiver for a Software Defined Radio (SDR) system, a feedforward synchronizer for an SDR receiver comprising such a transposed Farrow structure and a method for processing a received signal in an SDR receiver.

### BACKGROUND OF THE INVENTION

In communication systems (for example Software Defined Radio (SDR)), the timing in a data receiver must be aware of the timing of the symbols of the incoming data signal. In digitally implemented modems, in some circumstances, the sampling rate can be synchronized to the symbol rate of the incoming signal, but, in other circumstances, the sampling rate cannot be synchronized to the incoming signal and, for one reason or another, the sampling clock at the receiver must remain independent of the symbol timing of the received signal.

In that case, various ways of matching the receiver sampling rate to the incoming signal have been proposed.

One known arrangement (see for example Floyd M Gardner: “Interpolation in Digital Modems—Part I: Fundamentals”, IEEE Transactions on Communications, Vol 41, No. 3 March 1993, pp 501-507) proposes sampling the received signal at a fixed rate that is not in time with (i.e. asynchronous with) the symbol clock. After that there follows an interpolator which will output the re-sampled data in time with (i.e. synchronous with) the symbol clock. Usually, the time delay is estimated only for the asynchronous samples at the matched filter output and the interpolator has a filter with an impulse response that either precedes or follows the discrete-time matched filter. The sampling rate at the interpolator input is different from the sampling rate at the interpolator output.

However, this arrangement is not ideally suited to SDR applications, where flexible re-configurability, extensive adaptation and low complexity are required.

An arrangement which provides an improvement over the digital interpolation arrangement described above has been proposed (see Fredric J Harris and Michael Rice: Multirate Digital Filters for Symbol Timing Synchronization in Software Defined Radios”, IEEE Journal on Selected Areas in Communications, Vol. 19, No. 12, December 2002, pp 2346-2357) and provides a polyphase multi-rate filter used for symbol timing synchronization in SDR systems. In this arrangement, an up-sampled version of the matched filter is used as the interpolation filter and a polyphase decomposition of the up-sampled matched filter is used to gain implementation advantages. The advantages of this arrangement are that no separate interpolation filter is required and that maximum likelihood (ML) timing estimators can easily be incorporated into the timing recovery loop. However, the up-sampling factor of the matched filter may be too large when high accurate timing adjustment is required, and the complexity of the system increases quickly because of the storage increase for the polyphase filter's coefficients. Also, the arrangement only accommodates two functions: interpolation and matched filtering.

One known way to improve on the above known arrangements has been proposed and is named the Farrow Structure. (The Farrow Structure and the Transposed Farrow Structure, which will both be described below With reference to FIGS. 1 to 3, have been well described in, for example, Tim Hentschel and Gerhard Fettweis: “Continuous-Time Digital Filters for Sample-Rate Conversion in Reconfigurable Radio Terminals”, Proc. Of European Wireless Sep. 12-14, 2000, Dresden, Germany, pp 55-59.)

Consider an input signal r(kT₁) sampled at one rate, which needs to be converted to an output signal y(mT₂) sampled at a different rate. This is shown schematically in FIG. 1. T₁ is the time interval between samples for the input signal r (k T₁) (k representing the order of the sample of the input signal) and T₂ is the time interval between samples for the output signal y (m T₂) (m representing the order of the sample of the output signal).

The well-known sample rate conversion (SRC) equation relating the output signal to the input signal and describing the filtering and re-sampling of SRC for the case in FIG. 1 is:

$$y ( {mT}_{2} ) = {\sum }_{k = - ∞}^{∞} r ( {kT}_{1} ) \cdot h ( {mT}_{2} - {kT}_{1} ) \qquad [ 1 ]$$

h(t) is the continuous-time impulse response of the required signal, which delivers the signal y(mT₂) at the new sample rate from the input signal r(kT₁) at the old sample rate. Or, putting it another way, h(t) is a function representing the action the required filter performs on the input signal to convert it to the output signal.

Equation [1] describes a time-varying system.

It should be noted that we have Rational Factor SRC if

$$\frac{{T}_{1}}{{T}_{2}} = \frac{L}{M}$$

with L,MεN_{+.}

If L=1 or M=1, we have Integer Factor SRC (i.e. one of the sample rates is an exact multiple of the other sample rate). If L=M=1, we have discrete-time convolution (i.e. no SRC at all).

Generally, the complete continuous-time impulse response h(t) must be known. For rational and integer value SRC, described above, the system described by equation [1] varies periodically with time. So, only certain values of h(t) are actually required for the computation.

In order to simplify calculating the samples of h(t) which are required, we look for simple functions describing continuous time impulse responses. It has been found that, since polynomials are such simple functions, polynomial filters are useful in SRC. We limit the class of polynomial filters to piecewise polynomial impulse responses composed from pieces of equal length. Given polynomial pieces of degree Q and length Δ, we may derive an expression for h(t) as follows:

$$h ( t ) = {\sum }_{q = 0}^{Q} {c}_{q} ( ⌊ \frac{t}{Δ} ⌋ ) \cdot {( \frac{t}{Δ} - ⌊ \frac{t}{Δ} ⌋ )}^{q} , 0 \leq t < N Δ \qquad [ 2 ]$$

Where c_{q} is the coefficient for the q-th order polynomial.

There are two choices for Δ which simplify equation [2], namely Δ=T₁ and Δ=T₂. Using equation [2] and equation [1] above and setting Δ=T₁ gives:

$$y ( {mT}_{2} ) = {\sum }_{q = 0}^{Q} {x}_{q} ( {mT}_{2} ) \cdot {( {μ}_{m} )}^{q} \qquad [ 3 ]$$

where

$$\begin{matrix}{x}_{q} ( {mT}_{2} ) = {\sum }_{k = - ∞}^{∞} r ( {kT}_{1} ) \cdot {c}_{q} ( ⌊ m \frac{{T}_{2}}{{T}_{1}} ⌋ - k ) \\ and & [ 4 ] \\ {μ}_{m} = \frac{{mT}_{2}}{{T}_{1}} - ⌊ \frac{{mT}_{2}}{{T}_{1}} ⌋ ∈ [ 0 , 1 ) & [ 5 ]\end{matrix}$$

└a┘ denotes the floor operation i.e. └a┘ denotes the greatest integer a′ such that a′≦a.

μₘ is the inter-sample position i.e. the distance between the previous input signal and the current output signal (see FIG. 1) and has no units.

The above equations [3], [4] and [5] represent an implementation of SRC known as the Farrow structure and FIG. 2 shows a schematic illustration of such a structure.

The Farrow structure shown in FIG. 2 can also be interpreted as a polyphase interpolator with an infinite number of polyphase branches that are implemented by just one “reference” polyphase branch, and a polynomial description of how to calculate the remaining ones. The “reference” polyphase branch can be obtained by setting μₘ=0 in equation [3]. It represents the samples of the impulse response h(t) which mark the starting points of the individual polynomial pieces. These starting points (i.e. the “reference” branch) and the order of the connecting polynomial pieces determine the transfer characteristics of the SRC system.

In the Farrow structure equations [3], [4] and [5] above, the higher the order of the polynomial pieces, the better the impulse response h(t) can be matched to the application. If high order polynomials are not feasible, it is also possible to use shorter polynomials of lower order. In that case, more “reference” polyphase branches (i.e. starting points of polynomial pieces) are required. This can be achieved by decreasing the length of the polynomial pieces by a factor J, that is:

$$Δ = \frac{{T}_{1}}{J} \qquad [ 6 ]$$

This may be thought of as a generalization of the Farrow structure so is commonly known as the generalized Farrow structure (see for example R W Schafer and L R Rabiner: “A Digital Signal Processing Approach to Interpolation”, Proceedings of the IEEE, 61(6):692-702, June 1973).

Since equation [6] provides us with a generalization compared with the case where Δ=T₁, we can skip the case where Δ=T₂ and, instead, immediately set

$$Δ = \frac{{T}_{2}}{J} \qquad [ 7 ]$$

Substituting equations [6] and [7] into equation [2] above, we have:

$$y ( {mT}_{2} ) = {\sum }_{q = 0}^{Q} {\sum }_{k = - ∞}^{∞} {x}_{q} ( {kT}_{1} ) \cdot {c}_{q} ( mJ - ⌈ kJ \frac{{T}_{1}}{{T}_{2}} ⌉ ) \qquad [ 8 ]$$

where

$$\begin{matrix}{x}_{q} ( {kT}_{1} ) = r ( {kT}_{1} ) \cdot {( {μ}_{k} )}^{q} \\ and & [ 9 ] \\ {μ}_{k} = ⌈ kJ \frac{{T}_{1}}{{T}_{2}} ⌉ - kJ \frac{{T}_{1}}{{T}_{2}} ∈ [ 1 , 0 ) & [ 10 ]\end{matrix}$$

Note that when J=1, we return to the original Farrow structure and μₖ becomes equal to μₘ, the previously defined inter-sample position.

Equations [8], [9] and [10] above describe the Farrow structure when the piece length Δ of the polynomial pieces is defined by equation [7] above, and is known as the Transposed Farrow Structure (TFS). FIG. 3 shows a schematic illustration of such a TFS for J=1. Note that, in a real implementation, J is always equal to 1.

The Farrow Structure (FS) performs well in the case of sample rate increase but sample rate decrease is more commonly required in the receiver design. The Transposed Farrow Structure (TFS) provides an improvement over the FS, as it performs well for sample rate decrease, but the effectiveness of the TFS could still be improved.

It is an object of the invention to provide a modified Transposed Farrow Structure and method which reduces or substantially avoids the problems of known arrangements described above.

### SUMMARY OF THE INVENTION

According to a first aspect of the invention, there is provided a transposed Farrow structure for a Software Defined Radio (SDR) receiver, the transposed Farrow structure being arranged to implement:
sample rate conversion (SRC) for converting a received signal r having a sampling rate of 1/T₁ to a transmitted signal y having a sampling rate of 1/T₂;
timing adjustment using an estimated timing error τ; and
matched filtering of the received signal.

Preferably, the transposed Farrow structure equates the signal y to Q polynomial pieces.

In one preferred embodiment, the transposed Farrow structure comprises a first part for generating the Q polynomial pieces; and a second part for summing up the Q polynomial pieces to produce signal y.

The first part of the transposed Farrow structure may comprise a multiplier and plus network for generating Q polynomials for each order k of the received signal r, the Q polynomials being dependent on a timing parameter μ and the received signal r, the timing parameter μ being dependent on SRC factor T₁/T₂ and the timing error τ.

The first part of the transposed Farrow structure may further comprise an integration and dump circuit for summing the Q polynomials generated by the multiplier and plus network over all orders k of the received signal r to produce the Q polynomial pieces of the signal y,

the duration of the summation in the integration and dump circuit being controlled by an overflow factor, the overflow factor being dependent on SRC factor T₁/T₂ and the timing error τ.

The second part of the transposed Farrow structure may comprise a Finite Impulse Response Filter for summing up the Q polynomial pieces generated by the integration and dump circuit to produce signal y, the duration of the summation in the Finite Impulse Response Filter being controlled by the overflow factor.

The transposed Farrow structure may further comprise a unit for generating a timing parameter μ from T₁, T₂ and τ.

The transposed Farrow structure may further comprise a unit for generating an overflow factor from T₁, T₂ and τ.

According to a second aspect of the invention, there is provided a feedforward synchronizer for a Software Defined Radio (SDR) receiver, the feedforward synchronizer being arranged to receive a signal r having a sampling rate of 1/T₁ and comprising:
a feedforward estimator for generating an estimated timing error τ; and
a transposed Farrow structure arranged to receive the signal r and the estimated timing error τ and being arranged to implement: a) sample rate conversion (SRC) for converting the received signal r having a sampling rate of 1/T₁ to a transmitted signal y having a sampling rate of 1/T₂; b) timing adjustment using the estimated timing error τ; and c) matched filtering of the signal.

Preferably, the transposed Farrow structure equates the signal y to Q polynomial pieces.

In one embodiment, the transposed Farrow structure comprises a first part for generating the Q polynomial pieces; and a second part for summing up the Q polynomial pieces to produce signal y.

The first part of the transposed Farrow structure may comprise a multiplier and plus network for generating Q polynomials for each order k of the received signal r, the Q polynomials being dependent on a timing parameter μ and the received signal r, the timing parameter μ being dependent on SRC factor T₁/T₂ and the timing error τ.

The first part of the transposed Farrow structure may further comprise an integration and dump circuit for summing the Q polynomials generated by the multiplier and plus network over all orders k of the received signal r to produce the Q polynomial pieces of the signal y,

the duration of the summation in the integration and dump circuit being controlled by an overflow factor, the overflow factor being dependent on SRC factor T₁/T₂ and the timing error τ.

The second part of the transposed Farrow structure may comprise a Finite Impulse Response Filter for summing up the Q polynomial pieces generated by the integration and dump circuit to produce signal y, the duration of the summation in the Finite Impulse Response Filter being controlled by the overflow factor.

The transposed Farrow structure preferably comprises a portion for generating a timing parameter μ from T₁, T₂ and τ.

The transposed Farrow structure preferably comprises a portion for generating an overflow factor from T₁, T₂ and τ.

The feedforward estimator may comprise a maximum likelihood based estimator.

The feedforward estimator may comprise an unwrapped estimator for compensating for clock offset.

The feedforward estimator may comprise a differentiator.

The feedforward synchronizer may further comprising an anti-aliasing filter.

According to a third aspect of the invention, there is provided a method for processing a received signal r having a sampling rate of 1/T₁, in a Software Defined Radio (SDR) receiver comprising a transposed Farrow structure, the method comprising the steps of:
performing, in the transposed Farrow structure, sample rate conversion (SRC) for converting received signal r having a sampling rate of 1/T₁ to a transmitted signal y having a sampling rate of 1/T₂;
performing, in the transposed Farrow structure, timing adjustment using an estimated timing error τ; and
performing, in the transposed Farrow structure, matched filtering of the received signal.

Preferably, the transposed Farrow structure equates the signal y to Q polynomial pieces.

The method may comprise the steps of generating the Q polynomial pieces; and summing up the Q polynomial pieces to produce signal y.

The step of generating the Q polynomial pieces may comprise generating Q polynomials for each order k of the received signal r, the Q polynomials being dependent on a timing parameter μ and the received signal r, the timing parameter μ being dependent on SRC factor T₁/T₂ and the timing error τ.

The step of generating the Q polynomial pieces may further comprise summing the Q polynomials over all orders k of the received signal r to produce the Q polynomial pieces of the signal y, the duration of the summation in the integration and dump circuit being controlled by an overflow factor, the overflow factor being dependent on SRC factor T₁/T₂ and the timing error τ.

The step of summing up the Q polynomial pieces to produce signal y is preferably controlled by the overflow factor which controls the duration of the summation.

The method may further comprise the step of generating a timing parameter μ from T₁, T₂and τ.

The method may further comprise the step of generating an overflow factor from T₁, T₂ and τ.

Features described in relation to one aspect of the invention may be applicable to another aspect of the invention.

### BRIEF DESCRIPTION OF THE DRAWINGS

Known arrangements have already been described with reference to FIGS. 1 to 3, of which:

FIG. 1 is a schematic diagram illustrating the relationship between input and output sampling rates;

FIG. 2 is a diagram of the Farrow structure described by equations [3], [4] and [5]; and

FIG. 3 is a diagram of the transposed Farrow structure described by equations [8], [9] and [10].

Exemplary embodiments of the invention will now be described with reference to FIGS. 4 to 11, of which:

FIG. 4 is a diagram of a modified transposed Farrow structure (TFS) according to the invention;

FIG. 5 is a diagram of a feedforward synchronizer incorporating the modified TFS of FIG. 4;

FIG. 6 is a diagram of the feedforward estimator of FIG. 5;

FIG. 7 is a diagram of the unwrapped estimator of FIG. 5;

FIG. 8 is a diagram of the differentiator of FIG. 5;

FIG. 9 is a BER performance comparison of the arrangement of FIG. 5 with known arrangements;

FIG. 10 shows the estimated timing error in the presence of timing phase error and clock offset; and

FIG. 11 shows the constellation of π/4-DQPSK before and after timing synchronization.

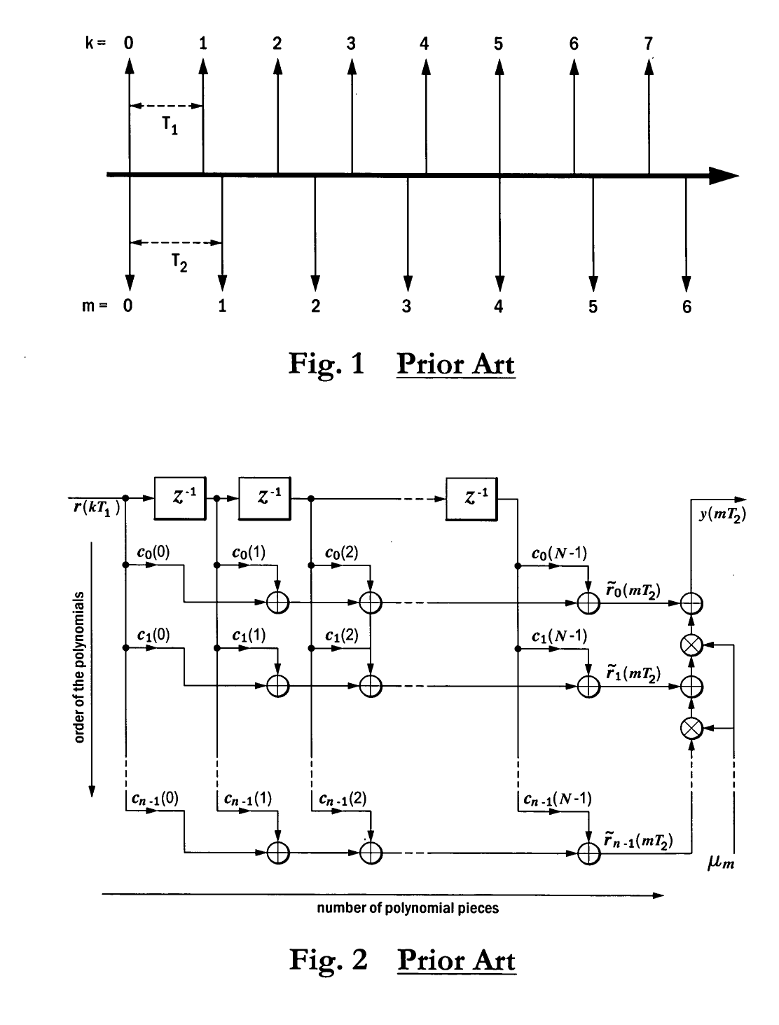

### DETAILED DESCRIPTION OF PREFERRED EMBODIMENTS

The invention provides a modified Transposed Farrow Structure (TFS). From equation [8], we have:

$$y ( {mT}_{2} ) = {\sum }_{q = 0}^{Q} {\sum }_{k = - ∞}^{∞} {x}_{q} ( {kT}_{1} ) \cdot {c}_{q} ( ⌊ m - k \frac{{T}_{1}}{{T}_{2}} ⌋ ) \qquad [ 11 ]$$

As before, y(mT₂) is the output and c_{q} is the coefficient for the q-th order (q running from 0 to Q). As before:

$${x}_{q} ( {kT}_{1} ) = r ( {kT}_{1} ) \cdot {( {μ}_{k} )}^{q} \qquad [ 10 ]$$

To simplify notation, we set:
μₖ=2μₖ′−1 [12]

which gives

$$\begin{matrix}{x}_{q} ( {kT}_{1} ) = r ( {kT}_{1} ) \cdot {( 2 {μ}_{k}^{′} - 1 )}^{q} \\ and & [ 13 ] \\ {μ}_{k}^{′} = m - \frac{{kT}_{1}}{{T}_{2}} - ⌊ m - \frac{{kT}_{1}}{{T}_{2}} ⌋ & [ 14 ]\end{matrix}$$

h(t), the function representing the action of the TFS is given by

$$h ( {mT}_{2} - {kT}_{1} ) = {\sum }_{q = 0}^{Q} {c}_{q} ( ⌊ m - k \frac{{T}_{1}}{{T}_{2}} ⌋ ) {( 2 ( m - k \frac{{T}_{1}}{{T}_{2}} - ⌊ m - k \frac{{T}_{1}}{{T}_{2}} ⌋ ) - 1 )}^{q} \qquad [ 15 ]$$

or more simply as

$$h ( {mT}_{2} - {kT}_{1} ) = {\sum }_{q = 0}^{Q} {c}_{q} ( ⌊ m - k \frac{{T}_{1}}{{T}_{2}} ⌋ ) {( 2 {μ}_{k}^{′} - 1 )}^{q} \qquad [ 16 ]$$

FIG. 4 shows implementation of the modified TFS according to one embodiment of the invention. The modified TFS structure includes a position sequence generator 401 receiving the SRC ratio T₁/T₂ and the timing error τ(k).

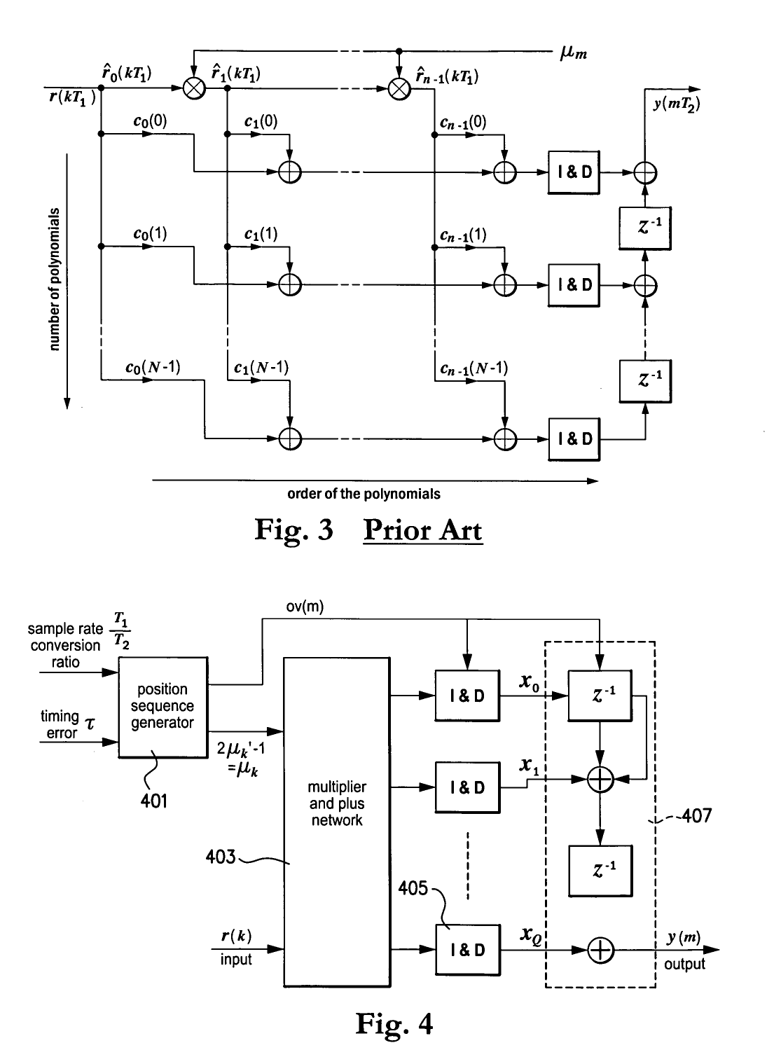

Also included is a multiplier and plus network 403 receiving μₖ(=2μₖ′−1) from the position sequence generator 401 and also receiving the input signal r(k). Also included are Integration and Dump (I&D) circuits 405, just as in the TFS of FIG. 3. Finally, there is a delay and adder unit—finite impulse response (FIR) filter 407, producing the output y(m). ov(m) is the overflow signal and will be discussed further below.

The modified TFS of FIG. 4 is used to implement the equation:

$$y ( {mT}_{2} ) = {\sum }_{q = 0}^{Q} {\sum }_{k = - ∞}^{∞} {x}_{q} ( {kT}_{1} ) \cdot {c}_{q} ( m - ⌈ k \frac{{T}_{1}}{{T}_{2}} ⌉ )$$

which is equation [8] with J=1. Essentially, the multiplier and plus network generates the

$${x}_{q} ( {kT}_{1} ) \cdot {c}_{q} ( m - ⌈ k \frac{{T}_{1}}{{T}_{2}} ⌉ ) ,$$

I&D circuits perform the inner summation over k and the FIR filter performs the outer summation over q.

In the multiplier and plus network 403, x_{q} for q=0 to Q is implemented in accordance with equation [13] from inputs r(k) and μₖ. Then, Q multipliers

$${x}_{q} ( {kT}_{1} ) {c}_{q} ( ⌊ m - k \frac{{T}_{1}}{{T}_{2}} ⌋ )$$

are implemented for each input r(k). These are the outputs of the multiplier and plus network 403. Then, in the duration that

$$( ⌊ m - k \frac{{T}_{1}}{{T}_{2}} ⌋ )$$

remains the same, the I&D circuits 405 perform the summation over k for each output from the multiplier and plus network 403. The FIR filter performs the summation over q thereby producing the left hand side of equation [8] i.e. y(m) as its output.

A tunable parameter for the modified TFS of FIG. 4 is μₖ′ and this is determined by the SRC ratio T₁/T₂ and derived at 401. The estimated timing error τ(k) is also used to control μₖ′ as can be seen at 401. By regenerating tunable parameter μₖ′ to integrate the timing error τ(k) as well as the SRC ratio T₁/T₂, the modified TFS can combine the functions of SRC, matched filtering and timing adjustment without a huge increase in complexity.

However, as k and m (i.e. the orders of the sample of the input and output signals) increase, the interpolation time grows unboundedly so the computation accuracy will soon deteriorate and the interpolation control will fail. Thus, a more suitable, but equivalent, computational method is needed. One way to do this is to use two separate timing parameters: the fractional interval μₖ and the basepoint index nₖ. In that case, we have:

$$\begin{matrix}{n}_{k + 1} = {n}_{k} + int [ {μ}_{k} + \frac{{T}_{1}}{{T}_{2}} + τ ( k ) ] & [ 17 ] \\ {n}_{k + 1} = frc [ {μ}_{k} + \frac{{T}_{1}}{{T}_{2}} + τ ( k ) ] & [ 18 ]\end{matrix}$$

Thus, the basepoint index at a particular order depends on the basepoint index at the previous order, the fractional interval at the previous order, the timing error at the previous order and the SRC ratio. The fractional interval at a particular order only depends on the fractional interval at the previous order, the timing error at the previous order and the SRC ratio. We can regard

$$int [ {μ}_{k} + \frac{{T}_{1}}{{T}_{2}} + τ ( k ) ]$$

in equation [17] as the number of input samples to be shifted into the interpolator until the next interpolant is computed.

In this embodiment, we introduce a new overflow accumulator, indexₖ where

$${index}_{k + 1} = ( {index}_{k} + \frac{{T}_{1}}{{T}_{2}} + τ ( k ) ) mod 1 \qquad [ 19 ]$$

Note that, in equation [19] we have included the timing error τ(k) so that we can combine the three functions: SRC, matched filtering and timing adjustment. This is clear from the fact that the SRC factor, the timing error and the overflow accumulator for the previous order are included in the definition of the overflow accumulator. We could define indexₖ₊₁ in another way by removing τ(k) from equation [19] so that only SRC and matched filtering are combined.

Equation [19] means that the sequence indexₖ is always <1 for k=0, . . . ,∞. The overflow signal ov(m) which was mentioned previously (one of the 401 outputs in FIG. 4) is defined as:

$$ov ( m ) = {index}_{k} + \frac{{T}_{1}}{{T}_{2}} + τ ( k ) \geq 1 \qquad [ 20 ]$$

As already mentioned, the I&D circuits 405 in FIG. 4 perform the summation of the multiplier and plus network outputs over k. The duration of the summation is controlled by the overflow signal. The integration operation continues until the overflow occurs. Then the dump operation is performed. Moreover, the overflow signal also controls the timing when the output y(m) is generated. Accurate overflow signal generation is the key for a successful TFS implementation.

Equations 19 and 20 give us:
μₖ′=1−indexₖ [21]

These new definitions allow the modified TFS to actually be implemented in hardware and the method is applicable to both rational and non-rational SRC systems integrated with timing adjustment interpolation. μₖ′ is tunable and incorporates the estimated timing error τ. The range of μₖ′ is defined as (0,1] rather than [0,1) as in conventional methods. The overflow condition is also changed. In the described embodiment, two separate steps are employed, to control the overflow accumulator indexₖ and generate inter-sample position μₖ′ respectively.

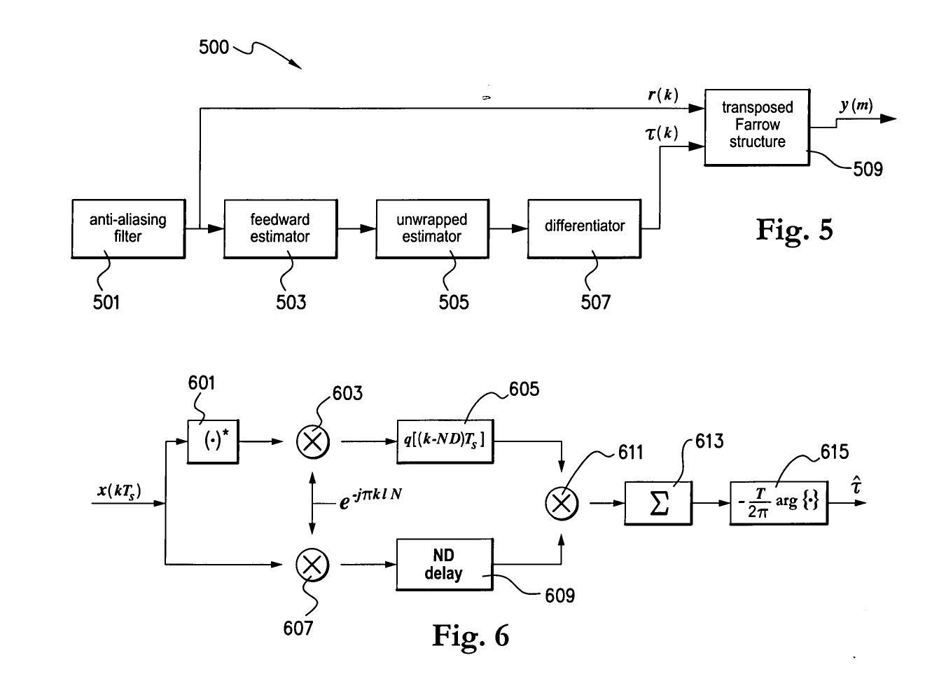

FIG. 5 shows a timing recovery loop incorporating the modified TFS of FIG. 4. FIG. 5 illustrates a feedforward synchronizer 500 comprising anti-aliasing filter 501, feedforward estimator 503, unwrapped estimator 505, differentiator 507 and modified TFS (according to FIG. 4) 509. The output of the differentiator 507 is the timing error estimate τ(k) which, as described above, is used, along with the input signal r(k) as input to the modified TFS 509. The output of the modified TFS 509 is y(m). (Note that, for baseband, the AAF is optional.)

Timing synchronization can be classified into two categories: feedback and feedforward. A feedforward synchronizer is preferred and described since feedback synchronization is not ideal for bursty transmission and can also face problems of false locking and locking losing in a poor channel condition.

Referring to FIG. 5, the received signal is fed to anti-aliasing filter (AAF) 501 and is then sampled at some rate 1/T₁. The samples from the AAF then input the feedforward estimator 503. The feedforward estimator 503 is shown in detail in FIG. 6.

FIG. 6 shows a Maximum-Likelihood (ML) based estimator. The ML based estimator and the O&M method (as described in, for example, Umberto Mengali and N. D'Andrea, “Synchronization Techniques for Digital Receivers (Applications of Communications Theory)”, Plenum Publishing Corporation, 1997) are two known non-data aided feedforward estimators which are essentially equivalent in performance. In this embodiment, a ML-based estimator is used.

In the estimator of FIG. 6, the samples from AAF 501 follow two separate branches. In the upper branch, the samples are first complex conjugated at 601. Then, the samples are multiplied by

$${ⅇ}^{\frac{- j 2 π k}{N}}$$

at operator block 603. Then, the samples are filtered at filter 605. In the lower branch, the samples are multiplied by

$${ⅇ}^{\frac{- j2 π k}{N}}$$

at operator block 607 then delayed at delay block 609.

The outputs from the two branches are then multiplied together at operator block 611 and then the product is accumulated at block 613. The argument of the accumulator output gives the timing estimate within a factor of

$$\frac{T}{2 π} .$$

Alternatively, we could use an O&M estimator instead of a ML-based estimator. In that case:

$$\hat{τ} = \frac{- T}{2 π} arg \{ {\sum }_{k = 0}^{{NL}_{0} - 1} {\vert x ( {kT}_{1} ) \vert}^{2} {ⅇ}^{\frac{- j2π k}{N}} \}$$

Where x(KT₁) are samples from the matched filter. The O&M algorithm seems more simple to implement than the ML-based scheme as it does not involve any filtering of x(kT₁). However, an oversampling of 4 is needed in an O&M estimator, whereas oversampling of 2 is sufficient with the ML-based method. In practice, the ML-based scheme is actually not as complex as expected, because the digitized signal generally comes from an efficient AAF followed by an analogue to digital converter.

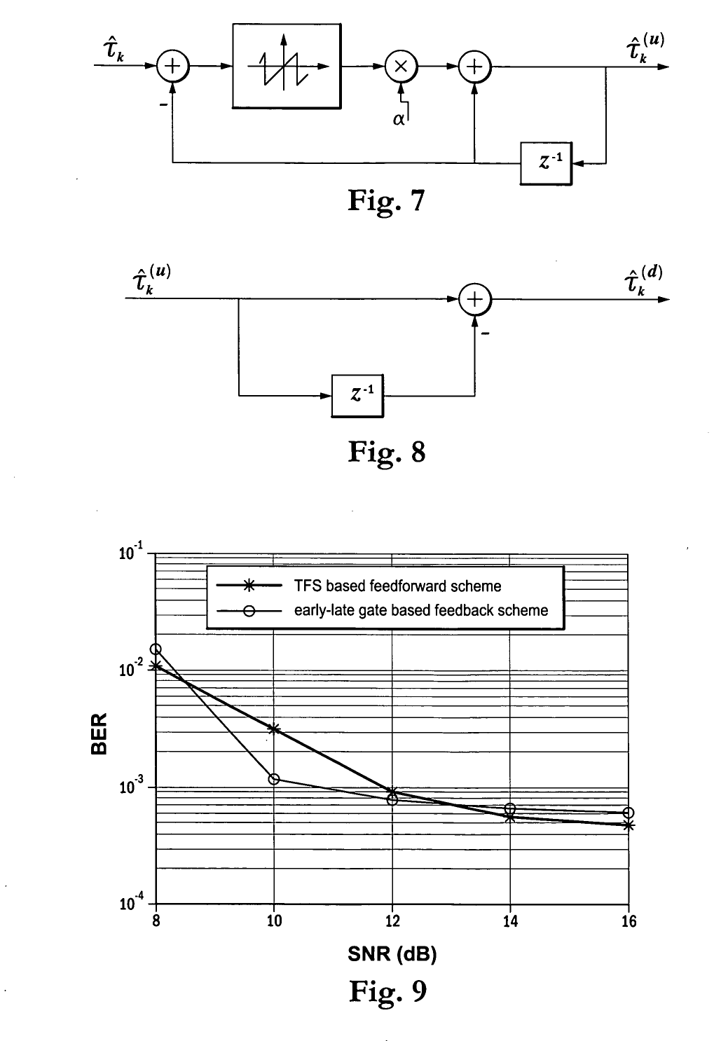

Referring again to FIG. 5, the output of the estimator 503 is fed into unwrapped estimator 505. The unwrapped estimator is shown in detail in FIG. 7. The purpose of the unwrapped estimator is to solve the problem caused by large clock offset. The timing error τ(k) varies in time due to the clock offset between the transmitter and the receiver. As \hat{τ} (i.e. the output of estimator 503 and input to unwrapped estimator 505) is restricted to

$$- \frac{{T}_{s}}{2} ⇒ \frac{{T}_{s}}{2} ,$$

it occasionally exhibits jumps of Ts seconds by jumping from one clock to another. If this is not properly accounted for, some strobes will be missed or duplicated. To solve this, the estimates \hat{τ} must be “unwrapped”—see Umberto Mengali and N. D'Andrea, “Synchronization Techniques for Digital Receivers (Applications of Communications Theory)”, Plenum Publishing Corporation, 1997.

Referring again to FIG. 5, the output of the unwrapped estimator 505 is fed into the differentiator 507. The differentiator is shown in detail in FIG. 8. Because the estimated timing error is accumulated at the frequency of the input clock and the feedforward synchronization is an open loop, a differentiator of the timing estimate is needed between the feedforward estimator (503, 505) and the modified TS (509) to counteract the accumulation effect.

Experimental data using the feedforward synchronizer of the present invention are shown in FIGS. 9, 10 and 11. A baseband transceiver is used with π/4-DQPSK modulation.

FIG. 9 shows a comparison of the BER of the synchronization scheme of the invention with a traditional feedback synchronization scheme. The conventional feedback scheme adopts the early-late gate timing estimator with an oversample factor of 4, a separate matched filter and an interpolation filter (the Farrow structure). In fact, that scheme has one of the best performances of any feedback scheme. It can be seen that the proposed feedforward scheme has equivalent performance as the traditional feedback method.

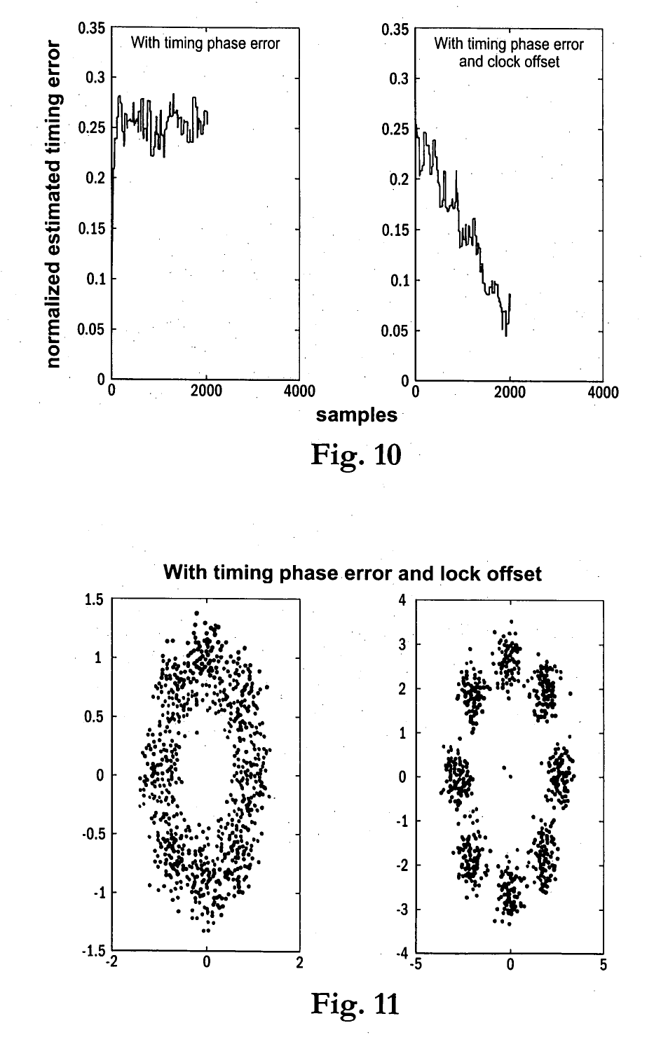

FIG. 10 shows the estimated timing error with timing phase error (left hand side) and with timing phase error and clock offset (right hand side). It can be seen that the proposed timing synchronization scheme can estimate the timing error with good accuracy and, at the same time, it can also track the clock frequency offset, which causes the phase to increase or decreases linearly.

FIG. 11 shows the π/4-DQPSK constellation when both timing phase error and clock offset are introduced into the system. The left hand side shows before timing synchronization and it can be seen that the constellation is not discernible. The right hand side shows the constellation with the timing synchronization of the invention; here a clearly distributed constellation is visible. There is a marked improvement to the constellation when the proposed scheme is adopted.

1. A transposed Farrow structure for a Software Defined Radio (SDR) receiver, the transposed Farrow structure being arranged to implement:
sample rate conversion (SRC) for converting a received signal r having a sampling rate of 1/T₁ to a transmitted signal y having a sampling rate of 1/T₂;
timing adjustment using an estimated timing error τ; and
matched filtering of the received signal.

2. A transposed Farrow structure according to claim 1, wherein the transposed Farrow structure equates the signal y to Q polynomial pieces.

3. A transposed Farrow structure according to claim 2 comprising:
a first part for generating the Q polynomial pieces; and
a second part for summing up the Q polynomial pieces to produce signal y.

4. A transposed Farrow structure according to claim 3 wherein the first part comprises:
a multiplier and plus network for generating Q polynomials for each order k of the received signal r, the Q polynomials being dependent on a timing parameter μ and the received signal r, the timing parameter μ being dependent on SRC factor T₁/T₂ and the timing error τ.

5. A transposed Farrow structure according to claim 4 wherein the first part further comprises:
an integration and dump circuit for summing the Q polynomials generated by the multiplier and plus network over all orders k of the received signal r to produce the Q polynomial pieces of the signal y,
the duration of the summation in the integration and dump circuit being controlled by an overflow factor, the overflow factor being dependent on SRC factor T₁/T₂ and the timing error τ.

6. A transposed Farrow structure according to claim 5 wherein the second part comprises:
a Finite Impulse Response Filter for summing up the Q polynomial pieces generated by the integration and dump circuit to produce signal y,
the duration of the summation in the Finite Impulse Response Filter being controlled by the overflow factor.

7. A transposed Farrow structure according to claim 1 comprising a unit for generating a timing parameter μ from T₁, T₂ and τ.

8. A transposed Farrow structure according to claim 1 comprising a unit for generating an overflow factor from T₁, T₂ and τ.

9. A feedforward synchronizer for a Software Defined Radio (SDR) receiver, the feedforward synchronizer being arranged to receive a signal r having a sampling rate of 1/T₁ and comprising:
a feedforward estimator for generating an estimated timing error τ; and
a transposed Farrow structure arranged to receive the signal r and the estimated timing error τ and being arranged to implement: a) sample rate conversion (SRC) for converting the received signal r having a sampling rate of 1/T₁ to a transmitted signal y having a sampling rate of 1/T₂; b) timing adjustment using the estimated timing error τ; and c) matched filtering of the signal.

10. A feedforward synchronizer according to claim 9, wherein the transposed Farrow structure equates the signal y to Q polynomial pieces.

11. A feedforward synchronizer according to claim 10 wherein the transposed Farrow structure comprises:
a first part for generating the Q polynomial pieces; and
a second part for summing up the Q polynomial pieces to produce signal y.

12. A feedforward synchronizer according to claim 11 wherein the first part of the transposed Farrow structure comprises:
a multiplier and plus network for generating Q polynomials for each order k of the received signal r, the Q polynomials being dependent on a timing parameter μ and the received signal r, the timing parameter μ being dependent on SRC factor T₁/T₂ and the timing error τ.

13. A feedforward synchronizer according to claim 12 wherein the first part of the transposed Farrow structure further comprises:
an integration and dump circuit for summing the Q polynomials generated by the multiplier and plus network over all orders k of the received signal r to produce the Q polynomial pieces of the signal y,
the duration of the summation in the integration and dump circuit being controlled by an overflow factor, the overflow factor being dependent on SRC factor T₁/T₂ and the timing error τ.

14. A feedforward synchronizer according to claim 13 wherein the second part of the transposed Farrow structure comprises:
a Finite Impulse Response Filter for summing up the Q polynomial pieces generated by the integration and dump circuit to produce signal y,
the duration of the summation in the Finite Impulse Response Filter being controlled by the overflow factor.

15. A feedforward synchronizer according to claim 9 wherein the transposed Farrow structure comprises a portion for generating a timing parameter μ from T₁, T₂ and τ.

16. A feedforward synchronizer according to claim 9 wherein the transposed Farrow structure comprises a portion for generating an overflow factor from T₁, T₂ and τ.

17. A feedforward synchronizer according to claim 9 wherein the feedforward estimator comprises a maximum likelihood based estimator.

18. A feedforward synchronizer according to claim 9 wherein the feedforward estimator comprises an unwrapped estimator for compensating for clock offset.

19. A feedforward synchronizer according to claim 9 wherein the feedforward estimator comprises a differentiator.

20. A feedforward synchronizer according to claim 9 further comprising an anti-aliasing filter.

21. A method for processing a received signal r having a sampling rate of 1/T₁, in a Software Defined Radio (SDR) receiver comprising a transposed Farrow structure, the method comprising the steps of:
performing, in the transposed Farrow structure, sample rate conversion (SRC) for converting received signal r having a sampling rate of 1/T₁ to a transmitted signal y having a sampling rate of 1/T₂;
performing, in the transposed Farrow structure, timing adjustment using an estimated timing error τ; and
performing, in the transposed Farrow structure, matched filtering of the received signal.

22. A method according to claim 21, wherein the transposed Farrow structure equates the signal y to Q polynomial pieces.

23. A method according to claim 22 comprising the steps of:
generating the Q polynomial pieces; and
summing up the Q polynomial pieces to produce signal y.

24. A method according to claim 23 wherein the step of generating the Q polynomial pieces comprises:
generating Q polynomials for each order k of the received signal r, the Q polynomials being dependent on a timing parameter μ and the received signal r, the timing parameter μ being dependent on SRC factor T₁/T₂ and the timing error τ.

25. A method according to claim 24 wherein the step of generating the Q polynomial pieces further comprises:
summing the Q polynomials over all orders k of the received signal r to produce the Q polynomial pieces of the signal y,
the duration of the summation in the integration and dump circuit being controlled by an overflow factor, the overflow factor being dependent on SRC factor T₁/T₂ and the timing error τ.

26. A method according to claim 25 wherein the step of summing up the Q polynomial pieces to produce signal y is controlled by the overflow factor which controls the duration of the summation.

27. A method according to claim 21 further comprising the step of generating a timing parameter μ from T₁, T₂ and τ.

28. A method according to claim 21 further comprising the step of generating an overflow factor from T₁, T₂ and τ.
